(19) United States
(12) Patent Application Publication
(10) Pub. No.: US 2014/0018469 A1
(43) Pub. Date: Jan. 16, 2014

(54) COMPOSITE MATERIAL CONTAINING CARBON NANOTUBES AND PARTICLES HAVING A CORE-SHELL STRUCTURE

(71) Applicants: Alexander Korzhenko, Pau (FR); Patrick Delprat, Lescar (FR); Catherine Bluteau, Orthez (FR)

(72) Inventors: Alexander Korzhenko, Pau (FR); Patrick Delprat, Lescar (FR); Catherine Bluteau, Orthez (FR)

(73) Assignee: ARKEMA FRANCE, Colombes (FR)

(21) Appl. No.: 14/007,882

(22) PCT Filed: Mar. 29, 2012
(86) PCT No.: PCT/FR2012/050668

§ 371 Date: Sep. 26, 2013

(30) Foreign Application Priority Data
Mar. 31, 2011 (FR) 11 52704

(51) Int. Cl. C08L 69/00; C08L 67/03

(52) U.S. Cl. CPC C08L 69/00; C08L 67/03
USPC 523/201; 524/496

(57) ABSTRACT

A composite material including, in a polymeric composition, carbon nanotubes combined with particles having an elastomeric core and at least one thermoplastic shell. The composite material including, in a polymer composition, carbon nanotubes associated, so as to form aggregations of less than 30 μm, with particles having a core made of totally or partially crosslinked elastomer and at least one thermoplastic shell, in a weight ratio of the particles of core-shell structure to the nanotubes of between 0.5:1 and 2.5:1. Also, a method for preparing said material, as well as to the use thereof for imparting various properties to polymeric matrices.

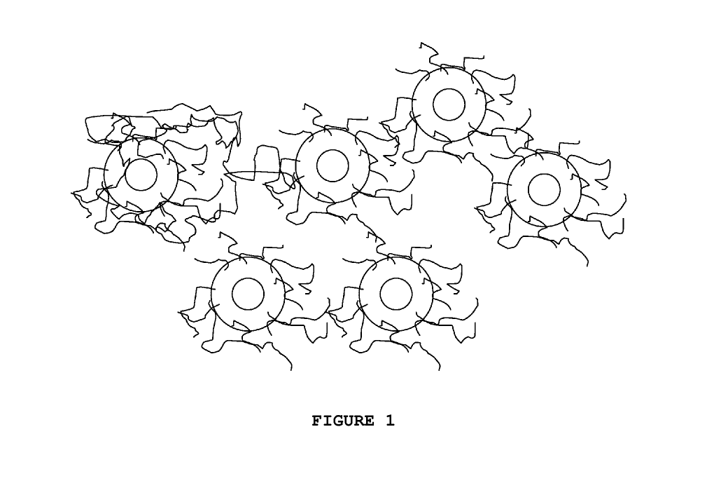

The present invention relates to a composite material comprising, in a polymer composition, carbon nanotubes combined, in a given weight ratio, with particles having a core made of at least partially crosslinked elastomer and at least one thermoplastic shell. The invention also relates to a process for preparing this material, and to the use thereof for giving polymer matrices different properties.

Carbon nanotubes (or CNT) have particular crystal structures, of hollow and closed tubular form, consisting of one or more rolled-up graphene leaflets, each of which is composed of carbon atoms regularly arranged in pentagons, hexagons and/or heptagons.

CNTs have excellent electrical and thermal conductivity properties, and also rigidity comparable to that of steel, which make it possible to envision using them as additives for imparting these properties to various materials, especially macromolecules.

However, their highly interlaced structure, due to the process for manufacturing them and to the existence of strong Van der Waals interactions, makes nanotubes difficult to disperse in polymer matrices, which has a negative impact on the mechanical properties of the composites obtained. Various techniques have been suggested for improving the dispersibility of CNTs, especially chemically, by functionalizing the CNTs in a highly oxidative medium, and via physical treatment, by “breaking” the aggregates with the aid of ultrasound. These approaches may, however, damage the structure of the CNTs and, by breaking the contact between them, impair their electrical conductivity properties. In addition, certain techniques make it possible to disperse CNT primary aggregates, but cannot prevent other aggregates from being formed during the manufacture and use of the composite.

There is thus still a need for a means for dispersing CNTs in polymer matrices under conditions that make it possible to control the morphology and distribution of the CNTs in the matrix, for the purpose of imparting thereto good mechanical properties and satisfactory electrical conductivity.

Now, the inventors have discovered that this need can be satisfied by combining CNTs with particular particles of core-shell type. It has in particular been observed that these particles formed with CNTs aggregates capable of giving the material containing them electrical and mechanical properties (especially impact strength and breaking resistance) that are improved relative to the same material lacking these particles.

These particles of core-shell structure are already known as agents which modify the impact strength of polymer matrices, especially based on thermoplastic resins such as polycarbonate (WO 2006/057 777) and PMMA (WO 2007/065 943). Moreover, document WO 2006/106 214 discloses polymer materials in which are dispersed CNTs in the presence of a dispersant which contains a block copolymer and optionally particles of core-shell type. In addition, document WO 2010/106 267 describes copolymers of core-shell structure of renewable origin, which may be used as impact additives in a polymer matrix optionally containing fillers such as carbon nanotubes.

For its part, document EP 2 188 327 uses core-shell particles to conserve the molecular weight of the polycarbonate during its compounding. Said document thus discloses a composite comprising polycarbonate (PC), carbon nanotubes (CNT) and a compound B which may be derived from the grafting, onto elastomer particles of polybutadiene type, of vinyl monomers consisting of a mixture of styrene and/or methyl methacrylate with another comonomer such as acrylonitrile. The example given thus illustrates, as compound B, core-shell particles of ABS type, comprising a polybutadiene core and a shell of styrene and acrylonitrile. However, the weight ratio of the core-shell particles (grafted polymer B) to the CNTs is always greater than or equal to 2.8.

Finally, document EP 2 166 038 discloses a flame-retardant composition, also based on PC, which has electrical conductivity and impact strength that are satisfactory for the manufacture of thin molded products. This composition contains, besides the PC, CNTs and a grafted copolymer C based on organopolysiloxane grafted with a crosslinking agent (f1), which may be divinylbenzene or allyl methacrylate, and on a monomer (f2) which is methyl methacrylate and/or styrene and/or acrylonitrile. In the case where these particles are of core-shell structure, their silicone core is not crosslinked, even partially.

It has, however, never been suggested that core-shell particles, used in a certain amount, namely in a weight ratio of the core-shell particles to the CNTs ranging from 0.5 to 2.5, are capable of establishing particular physical interactions with CNTs, making it possible to improve the electrical and mechanical properties of a polymer matrix. On the contrary, the inventors have revealed the capacity of carbon nanotubes for combining with core-shell particles to form aggregations of less than 30 μm, as illustrated in the attached FIGURE, and have demonstrated that these aggregations are responsible for improving the abovementioned properties. In addition, the inventors have revealed that the crosslinking of the core of the core-shell particles contributes toward maintaining the structure and the solidity of these particles during compounding with CNTs and thus toward obtaining the desired morphology of the aggregates formed with CNTs.

One subject of the present invention is thus a composite material comprising, in a polymer composition, carbon nanotubes combined, so as to form aggregations of less than 30 μm, with particles having a core made of totally or partially crosslinked elastomer and at least one thermoplastic shell, in a weight ratio of the particles of core-shell structure to the nanotubes of between 0.5:1 and 2.5:1 and preferably between 1.5:1 and 2.5:1.

A subject of the invention is also a process for preparing this composite material, which is in the form of a masterbatch or of a composite product, said process comprising the successive steps consisting in:

(a) introducing, and then blending, in a compounding device, the carbon nanotubes, the polymer composition and optional additives, to obtain a homogeneous mixture,
(b) adding the particles of core-shell structure to said mixture in said device,
(c) extruding and recovering, in agglomerated solid form such as granules, the composition derived from step (b), to obtain a masterbatch,
(d) optionally, diluting said masterbatch in a polymer matrix containing at least one polymer chosen from: an elastomer resin base, a thermosetting resin base and a thermoplastic polymer, to obtain a composite product.

A subject of the invention is also the use of this composite material as masterbatch, for improving the electrical, thermal and/or mechanical properties of a polymer matrix.

It is understood that, throughout this description, the term “between” is understood as including each of the mentioned limits.

### Composite Material

The composite material according to the invention comprises carbon nanotubes, particles of core-shell structure and a polymer composition. In this material, the carbon nanotubes and the core-shell particles form aggregations whose means size (median diameter D50), observed by optical microscopy, is less than 30 μm.

These constituents will now be described in greater detail.

### Carbon Nanotubes

The carbon nanotubes used according to the invention may be single-wall nanotubes (or SWNT) or multi-wall nanotubes (or MWNT). Double-wall nanotubes may especially be prepared as described by Flahaut et al. in Chem. Com. (2003), 1442. Multi-wall nanotubes may, for their part, be prepared as described in document WO 03/02456.

The nanotubes used according to the invention usually have a mean diameter ranging from 0.1 to 100 nm, preferably from 0.4 to 50 nm and better still from 5 to 30 nm and advantageously a length of more than 0.1 μm and advantageously from 0.1 to 20 μm, for example from about 5 to 10 μm. Their length/diameter ratio is advantageously greater than 10 and usually greater than 100. These nanotubes may especially be obtained by chemical vapor deposition. Their specific surface area is, for example, between 100 and 300 m²/g, preferably between 200 and 250 m²/g, and their apparent density may especially be between 0.01 and 0.5 g/cm³ and more preferentially between 0.07 and 0.2 g/cm³. Multi-wall carbon nanotubes may, for example, comprising from 5 to leaflets and more preferentially from 7 to 10 leaflets.

An example of raw carbon nanotubes is especially commercially available from the company Arkema under the trade name Graphistrength® C100.

The nanotubes may be purified and/or treated (in particular oxidized) and/or milled, before being used in the present invention. They may also be functionalized via chemical methods in solution such as amination or reaction with coupling agents.

The milling of the nanotubes may especially be performed with or without heating and may be performed according to the known techniques performed in apparatus such as ball mills, hammer mills, attrition mills, knife mills, gas-jet mills or any other milling system that is capable of reducing the size of the interlaced network of nanotubes. It is preferable for this milling step to be performed according to a technique of gas-jet milling, in particular in an air-jet mill.

The purification of the nanotubes may be performed by washing using a sulfuric acid solution, or that of another acid, so as to free them of any residual mineral and metallic impurities, originating from their preparation process. The weight ratio of the nanotubes to sulfuric acid may especially be between 1:2 and 1:3. The purification operation may moreover be performed at a temperature ranging from 90 to 120° C., for example for a time of 5 to 10 hours. This operation may advantageously be followed by steps of rinsing with water and drying of the purified nanotubes. Another route for purifying the nanotubes, which is intended in particular for removing the iron and/or magnesium they contain, consists in subjected them to a heat treatment above 1000° C.

The oxidation of the nanotubes is advantageously performed by placing them in contact with a sodium hypochlorite solution containing from 0.5% to 15% by weight of NaOCl and preferably from 1% to 10% by weight of NaOCl, for example in a weight ratio of the nanotubes to sodium hypochlorite ranging from 1:0.1 to 1:1. The oxidation is advantageously performed at a temperature of less than 60° C. and preferably at room temperature, for a time ranging from a few minutes to 24 hours. This oxidation operation may advantageously be followed by steps of filtration and/or centrifugation, washing and drying of the oxidized nanotubes.

It is, however, preferred for the nanotubes to be used in the present invention in crude form.

Moreover, it is preferred according to the invention to use nanotubes obtained from starting materials of renewable origin, in particular of plant origin, as described in document FR 2 914 634.

The composite material according to the invention contains, for example, from 0.1% to 40% by weight, preferably from 1% to 30% by weight and more preferentially from 10% to 20% by weight of carbon nanotubes. When it constitutes a masterbatch, it is preferable for it to contain from 5% to 40% by weight and more preferentially from 10% to 30% by weight of carbon nanotubes. When it constitutes a composite product, it is preferable for it to contain from 0.1% to 10% by weight and more preferentially from 1% to 8% by weight, or even from 1% to 5% by weight, of carbon nanotubes.

### Particles of Core-Shell Structure

The particles of core-shell structure used according to the invention contain an elastomer core, which is at least partially crosslinked and optionally arranged around a rigid nucleus, said core being covered with one or more thermoplastic shells.

The rigid nucleus, when it is present, may be formed from at least one thermoplastic polymer with a glass transition temperature (Tg) of greater than 25° C., preferably between 40 and 150° C. and more preferentially between 60 and 140° C., such as a poly(alkyl(meth)acrylate), in particular poly(methyl methacrylate).

These particles generally have a size, expressed as their median diameter D50, measured by transmission electron microscopy, of between 50 and 1000 nm, advantageously between 150 and 500 nm and more preferentially between 160 and 400 nm. They may be prepared by emulsion polymerization, for example by polymerizing one or more monomers that will form the shell in the presence of a latex containing an elastomer that will form the core of the particles. Polymerization initiators chosen from persulfates, organic peroxides and azo compounds, for example, may be used.

The elastomer core may itself be obtained by emulsion radical polymerization according to known methods, for example at a temperature from 40 to 80° C. Advantageously, part of the monomers may be introduced into the reaction medium before the polymerization, and the rest continuously after the polymerization reaction has been initiated.

The elastomer forming the core of the particles used according to the invention generally has a glass transition temperature (Tg) of between −120 and 0° C. and preferably between −90 and −10° C.

The core may be chosen, for example, from the group consisting of:
isoprene or butadiene homopolymers or an alkyl(meth)acrylate homopolymer, and
copolymers of isoprene with up to 30 mol % of a vinyl monomer, copolymers of butadiene with up to 30 mol % of a vinyl monomer and copolymers of an alkyl(meth)acrylate with up to 30 mol % of a vinyl monomer.

The vinyl monomer is advantageously chosen from the group consisting of styrene, an alkylstyrene such as α-methylstyrene, acrylonitrile, butadiene, isoprene and an alkyl(meth)acrylate, it being understood that said vinyl monomer is different from the monomer with which it is copolymerized.

The alkyl(meth)acrylates that may be used in the core of the particles especially comprise ethyl acrylate, n-butyl acrylate, 2-ethylhexyl acrylate, n-octyl acrylate and methyl methacrylate, without this list being limiting.

Crosslinking of the core is obtained by adding at least difunctional monomers during its preparation. These monomers may be chosen from poly(meth)acrylic esters of polyols such as butylene glycol di(meth)acrylate, ethylene glycol dimethacrylate and trimethylolpropane trimethacrylate. Other difunctional monomers are, for example, divinylbenzene, divinyltoluene, trivinyl-benzene, vinyl acrylate, vinyl methacrylate, allyl acrylate and allyl methacrylate. The core may also be crosslinked by introducing therein, by grafting or as a comonomer during the polymerization, unsaturated functional monomers such as unsaturated carboxylic acid anhydrides, unsaturated carboxylic acids and unsaturated epoxides or allyl cyanurates. Examples that may be mentioned include maleic anhydride, (meth)acrylic acid and glycidyl methacrylate. It is preferable according to the invention for the core to be crosslinked.

Chain-transfer agents such as t-dodecyl mercaptan, n-octyl mercaptan, and mixtures thereof, may also be introduced into the core. The chain-transfer agent may represent from 0 to 2% by weight and preferably from 0.2% to 1% by weight relative to the weight of the monomers forming the core.

The core may thus, for example, comprise from 90 mol % to 100 mol % of butadiene and of a crosslinking agent and from 0 to 10 mol % of styrene, especially from 90 mol % to 95 mol % of butadiene and of a crosslinking agent and from 5 mol % to 10 mol % of styrene. As a variant, as described in patent application WO 2006/057 777, it may comprise from 95 mol % to 100 mol % of butadiene and of a crosslinking agent and from 0 to 5 mol % of styrene.

The particles of core-shell structure also contain one or more shells. In the description that follows, the term “shell” consequently means the single shell, or each of the shells independently, where appropriate.

The shell is formed from at least one thermoplastic polymer with a glass transition temperature (Tg) of greater than 25° C., preferably between 40 and 150° C. and more preferentially between 60 and 140° C.

The shell advantageously consists of:
a styrene homopolymer, an alkylstyrene homopolymer (such as α-methylstyrene) or a methyl methacrylate homopolymer; or
a copolymer comprising at least 70 mol % of a major monomer chosen from styrene, an alkylstyrene (such as α-methylstyrene) or methyl methacrylate and at least one comonomer chosen from:
   a C₁-C₂₀ and preferably C₁-C₈ alkyl(meth)acrylate, such as methyl methacrylate, ethyl methacrylate, ethyl acrylate and n-butyl acrylate,
   vinyl acetate,
   unsaturated nitriles, such as acrylonitrile and methacrylonitrile,
   acrylamides, in particular dimethylacrylamide,
   a vinylaromatic compound such as styrene, α-methylstyrene, vinyltoluene and vinylnaphthalene, which are optionally halogenated and/or alkylated, such as chlorostyrene, dibromostyrene and tribromostyrene,
   vinyl monomers containing a glycidyl group, such as glycidyl acrylate, glycidyl methacrylate, allyl glycidyl ether and ethylene glycol glycidyl ether, and
   mixtures thereof,
      it being understood that the major monomer and the comonomer are different.

It is preferable according to the invention for the shell to be formed from an alkyl(meth)acrylate, preferably methyl methacrylate, ethyl acrylate and/or n-butyl acrylate, and/or from styrene.

The shell may be functionalized by introducing therein, by grafting or as a comonomer during the polymerization, unsaturated functional monomers such as unsaturated carboxylic acid anhydrides, unsaturated carboxylic acids, unsaturated epoxides or allyl cyanurates. Examples that may be mentioned include maleic anhydride, (meth)acrylic acid and glycidyl methacrylate.

As examples of particles of core-shell structure, mention may be made of core-shell copolymers having a polystyrene shell and core-shell copolymers having a polymethyl methacrylate shell. Core-shell copolymers having two shells also exist, one being made of polystyrene and the other to the exterior made of polymethyl methacrylate. Examples of particles of core-shell structure, and of a process for preparing them, are described in the following patents: U.S. Pat. No. 4,180,494, U.S. Pat. No. 3,808,180, U.S. Pat. No. 4,096,202, U.S. Pat. No. 4,260,693, U.S. Pat. No. 3,287,443, U.S. Pat. No. 3,657,391, U.S. Pat. No. 4,299,928, U.S. Pat. No. 3,985,704, U.S. Pat. No. 5,773,520.

Advantageously, the core represents from 70% to 90% by weight, for example from 75% to 80% by weight, and the shell (or shells) from 30% to 10% by weight, for example from 20% to 15% by weight, relative to the weight of the particles of core-shell structure.

The copolymer constituting the core-shell particles according to the invention may be of the soft/hard type. By way of example of copolymers of the soft/hard type, mention may be made of the product comprising:

(i) from 75 to 80 parts of a core comprising, on a molar basis, at least 93% of a butadiene, 5% of styrene and 0.5% to 1% of divinylbenzene, and
(ii) from 25 to 20 parts of two cores essentially of the same weight, the inner one made of polystyrene and the outer one made of polymethyl methacrylate.

As another example of a copolymer of soft/hard type, mention may be made of the product having a core made of poly(butyl acrylate) or of a copolymer of butyl acrylate and of butadiene and a shell of polymethyl methacrylate.

The copolymer constituting the core-shell particles may also be of the hard/soft/hard type, i.e. it contains, in this order, a hard shell, a soft shell and a hard shell. The hard parts may consist of polymers of the shell of the preceding soft/hard parts and the soft part may consist of polymers of the core of the preceding soft/hard parts. An example that may be mentioned is a particulate copolymer of hard/soft/hard type comprising:

(i) a core made of a copolymer of methyl methacrylate and ethyl acrylate,
(ii) a shell made of a copolymer of n-butyl acrylate and styrene,
(iii) a shell made of a copolymer of methyl methacrylate and ethyl acrylate.

The copolymer constituting the core-shell particles may also be of the hard (core)/soft/half-hard type. In this case, the “half-hard” outer shell consists of two shells, the intermediate shell and the outer shell. The intermediate shell may be a copolymer of methyl methacrylate, styrene and at least one monomer chosen from alkyl acrylates, butadiene and isoprene. The outer shell may be polymethyl methacrylate or a copolymer of methyl methacrylate, styrene and at least one monomer chosen from alkyl acrylates, acrylamides (in particular dimethylacrylamide), a butadiene and isoprene.

An example of a hard/soft/half-hard copolymer is that comprising, in this order:

(i) a core made of a copolymer of methyl methacrylate and ethyl acrylate,
(ii) a shell made of a copolymer of n-butyl acrylate and styrene,
(iii) a shell made of a copolymer of methyl methacrylate, n-butyl acrylate and styrene,
(iv) a shell made of a copolymer of methyl methacrylate and ethyl acrylate.

In the embodiments of the invention using particles of core-shell structure in which the core and/or the shell contain a (meth)acrylic polymer, in particular methyl methacrylate, it is possible to use, for the manufacture of these polymers, monomers obtained from non-fossil carbon sources, in particular from biomass, as described in document WO 2010/106 267.

The composite material according to the invention contains, for example, from 0.1% to 80% by weight, preferably from 1% to 60% by weight, more preferably from 1% to 50% by weight and better still from 2% to 40% by weight of particles of core-shell structure. When it constitutes a masterbatch, it is preferable for it to contain at least 5% by weight, preferably at least 20% by weight, or even at least 25% by weight of particles of core-shell structure and, for example, not more than 80% by weight, preferably not more than 50% by weight, or even not more than 30% by weight, of particles of core-shell structure. When it constitutes a composite product, it is preferable for it to contain from 0.1% to 15% by weight, preferably from 1% to 12% by weight and more preferentially from 2% to 6% by weight of particles of core-shell structure.

### Polymer Composition

The polymer composition used according to the invention contains at least one polymer, which may be a thermoplastic polymer, an elastomeric resin base or a thermosetting resin base.

According to a first embodiment of the invention, the polymer composition contains a thermoplastic polymer. For the purposes of the present invention, the term “thermoplastic polymer” means a polymer which melts when it is heated and which can be reshaped when molten.

This thermoplastic polymer may be chosen especially from: olefin homopolymers and copolymers such as acrylonitrile-butadiene-styrene copolymers, polyethylene, polypropylene, polybutadiene and polybutylene; acrylic homopolymers and copolymers and poly(alkyl(meth)acrylates) such as poly(methyl methacrylate); homopolyamides and copolyamides; polycarbonates; polyesters including poly(ethylene terephthalate) and poly(butylene terephthalate); polyethers such as poly(phenylene ether), poly(oxymethylene) and poly(oxyethylene) or poly(ethylene glycol); polystyrene; copolymers of styrene and maleic anhydride; poly(vinyl chloride); fluoro polymers such as poly(vinylidene fluoride), polytetrafluoroethylene and polychlorotrifluoroethylene; natural or synthetic rubbers; thermoplastic polyurethanes; polyaryl ether ketones (PAEK) such as polyether ether ketone (PEEK) and polyether ketone ketone (PEKK); polyetherimide; polysulfone; poly(phenylene sulfide); cellulose acetate; poly(vinyl acetate); and mixtures thereof.

According to one embodiment, the polymer is chosen from homopolyamides and copolyamides.

Among the homopolyamides (PA), mention may be made especially of PA-6, PA-11 and PA-12, obtained by polymerization of an amino acid or a lactam, PA-6.6, PA-4.6, PA-6.10, PA-6.12, PA-6.14, PA-6-18 and PA-10.10 obtained by polycondensation of a diacid and a diamine, and also aromatic polyamides such as polyarylamides and polyphthalamides. Some of the abovementioned polymers (PA-11, PA-12, aromatic PAs) are especially available from the company Arkema under the trade name Rilsan®.

The copolyamides, or polyamide copolymers, may be obtained from various starting materials: (i) lactams, (ii) aminocarboxylic acids or (iii) equimolar amounts of diamines and of dicarboxylic acids. The production of a copolyamide requires a choice of at least two different starting materials from among those mentioned previously. The copolyamide then comprises at least these two units. It may thus be a case of a lactam and an aminocarboxylic acid having a different number of carbon atoms, or of two lactams of different molecular masses, or alternatively of a lactam combined with an equimolar amount of a diamine and a dicarboxylic acid. The lactams (i) may be chosen in particular from lauryllactam and/or caprolactam. The aminocarboxylic acid (ii) is advantageously chosen from α,ω-aminocarboxylic acids such as 11-aminoundecanoic acid or 12-aminododecanoic acid. For its part, the precursor (iii) may especially be a combination of at least one aliphatic, cycloaliphatic or aromatic C₆-C₃₆ dicarboxylic acid, such as adipic acid, azelaic acid, sebacic acid, brassylic acid, n-dodecanedioic acid, terephthalic acid, isophthalic acid or 2,6-naphthalene dicarboxylic acid with at least one aliphatic, cycloaliphatic, arylaliphatic or aromatic C₄-C₂₂ diamine, such as hexamethylene diamine, piperazine, 2-methyl-1,5-diaminopentane, m-xylylenediamine or p-xylylenediamine; it being understood that said dicarboxylic acid(s) and diamine(s) are used, when they are present, in equimolar amount. Such copolyamides are sold especially under the trade name Platamid® by the company Arkema.

In a second embodiment of the invention, the polymer composition contains an elastomeric resin base. In the present description, the term “elastomeric resin base” means an organic or silicone polymer, which forms, after vulcanization, an elastomer that is capable of withstanding large deformations virtually reversibly, i.e. it is capable of being subjected to a uniaxial deformation, advantageously of at least twice its original length at room temperature (23° C.) for five minutes, and then of regaining, once the stress has been removed, its initial dimensions, with a remanent deformation of less than 10% of its initial dimension.

From a structural point of view, the elastomers generally consist of polymer chains linked together to form a three-dimensional network. More precisely, a distinction is occasionally made between thermoplastic elastomers, in which the polymer chains are linked together via physical bonds, such as hydrogen bonds or dipole-dipole bonds, and thermosetting elastomers, in which these chains are linked together via covalent bonds, which constitute points of chemical crosslinking. These crosslinking points are formed via vulcanization processes using a vulcanizing agent which may be chosen, for example, depending on the nature of the elastomer, from sulfa-based vulcanizing agents, in the presence of metal salts of dithiocarbamates; zinc oxides combined with stearic acid; optionally halogenated difunctional phenol-formaldehyde resins, in the presence of tin chloride or zinc oxide; peroxides; amines; hydrosilanes in the presence of platinum; etc.

The present invention more particularly relates to elastomeric resin bases containing, or consisting of, thermosetting elastomers optionally as a mixture with unreactive elastomers, i.e. non-vulcanizable elastomers (such as hydrogenated rubbers).

The elastomeric resin bases that may be used according to the invention may especially comprise, or even may consist of, one or more polymers chosen from: fluorocarbon or fluorosilicone elastomers; butadiene homopolymers and copolymers, optionally functionalized with unsaturated monomers such as maleic anhydride, (meth)acrylic acid, acrylonitrile (NBR) and/or styrene (SBR); neoprene (or polychloroprene); polyisoprene; copolymers of isoprene with styrene, butadiene, acrylonitrile and/or methyl methacrylate; copolymers based on propylene and/or ethylene and especially terpolymers based on ethylene, propylene and dienes (EPDM), and also copolymers of these olefins with an alkyl(meth)acrylate or vinyl acetate; halogenated butyl rubbers; silicone elastomers such as poly(dimethylsiloxanes) bearing vinyl end groups; polyurethanes; polyesters, acrylic polymers such as poly(butyl acrylate) bearing carboxylic acid or epoxy functions; and also modified or functionalized derivatives thereof, and mixtures thereof, without this list being limiting.

In a third embodiment, the polymer composition according to the invention contains a thermosetting resin base. In the present description, the term “thermosetting resin base” means a material that is generally liquid at room temperature, or with a low melting point, which is capable of being hardened, generally in the presence of a hardener, under the effect of heat, a catalyst or a combination of the two, to obtain a thermoset resin. This resin consists of a material containing polymer chains of variable length linked together via covalent bonds, so as to form a three-dimensional network. As regards its properties, this thermoset resin is unmeltable and insoluble. It may be softened by heating it beyond its glass transition temperature (Tg), but, once a shape has been given thereto, it cannot be subsequently reshaped by heating.

The thermosetting resins that may be used according to the invention comprise: unsaturated polyesters, epoxy resins, vinyl esters, phenolic resins, polyurethanes, cyanoacrylates and polyimides, such as bis-maleimide resins, aminoplasts (resulting from the reaction of an amine such as melamine with an aldehyde such as glyoxal or formaldehyde), and mixtures thereof, without this list being limiting.

The unsaturated polyesters result from the condensation polymerization of dicarboxylic acids containing an unsaturated compound (such as maleic anhydride or fumaric acid) and of glycols such as propylene glycol. They are generally hardened by dilution in a reactive monomer, such as styrene, followed by reaction of the latter with the unsaturations present on these polyesters, generally by means of peroxides or a catalyst, in the presence of salts of heavy metals or of an amine, or alternatively by means of a photoinitiator, ionizing radiation, or a combination of these various techniques.

The vinyl esters comprise the products of reaction of epoxides with (meth)acrylic acid. They may be hardened after dissolution in styrene (in a similar manner to polyester resins) or by means of organic peroxides.

The epoxy resins consist of materials containing one or more oxirane groups, for example from 2 to 4 oxirane functions per molecule. When they are polyfunctional, these resins may consist of linear polymers bearing epoxy end groups, or polymers whose backbone comprises epoxy groups, or alternatively whose backbone bears epoxy side groups. They generally require as hardener an acid anhydride or an amine.

These epoxy resins may result from the reaction of epichlorohydrin with a bisphenol such as bisphenol A. As a variant, they may be alkyl and/or alkenyl glycidyl ethers or esters; polyglycidyl ethers of monophenols and polyphenols, which are optionally substituted, especially polyglycidyl ethers of bisphenol A; polyglycidyl ethers of polyols; polyglycidyl ethers of aliphatic or aromatic polycarboxylic acids; polyglycidyl esters of polycarboxylic acids; polyglycidyl ethers of novolac. As a further variant, they may be products of the reaction of epichlorohydrin with aromatic amines or of aromatic monoamine or diamine glycidyl derivatives. Use may also be made in this invention of cycloaliphatic epoxides. It is preferred according to the invention to use diglycidyl ethers of bisphenol A (or BADGE), F or A/F.

According to a preferred embodiment of the invention, the polymer composition comprises at least one thermoplastic polymer.

### Other Constituents

Besides the abovementioned constituents, the composite material according to the invention may comprise at least one filler other than the CNTs, chosen from: carbon black, graphene-based fillers, fullerenes, graphite, carbon nanofibers, glass fibers, fibers of plant origin, mineral fillers, and mixtures thereof.

However, it is preferable for this material to consist of the mixture of nanotubes, particles of core-shell structure, the polymer composition and optionally at least one non-polymeric additive such as a plasticizer, the polymer composition containing at least 90% by weight, preferably at least 95% by weight and more preferentially 100% by weight of one or more polymers.

Besides the abovementioned polymers, these polymers may comprise polymeric additives, intended in particular for promoting the subsequent dispersion of the composite material in a liquid formulation, in particular carboxymethylcellulose, acrylic polymers, the polymer sold by the company Lubrizol under the trade name Solplus® DP310 and functionalized amphiphilic hydrocarbons such as the product sold by the company Trillium Specialties under the brand name Trilsperse® 800. As a variant, the polymeric additive may consist of a polymeric plasticizer, such as a cyclic butyl terephthalate oligomer (especially the resin CBT® 100 from Cyclics).

The non-polymeric additives optionally included in the composite material according to the invention in particular comprise non-polymeric plasticizers, surfactants such as sodium dodecylbenzenesulfonate, mineral fillers such as silica, titanium dioxide, talc or calcium carbonate, UV-screening agents, especially based on titanium dioxide, flame retardants, solvents for the polymer, heat stabilizers or light stabilizers, especially based on phenol or phosphite, and mixtures thereof.

### Preparation Process

The process for preparing the composite material according to the present invention will now be described in greater detail.

This process comprises a first step of introducing into a compounding device carbon nanotubes, polymer composition and optional additives described previously.

In the present description, the term “compounding device” means apparatus conventionally used in the plastics industry for the melt blending of thermoplastic polymers and additives in order to produce composites. In this apparatus, the polymer composition and the additives are mixed by means of a high-shear device, for example a co-rotating or counter-rotating twin-screw extruder or a co-kneader. The molten material generally exits the apparatus in an agglomerated solid physical form, for example in the form of granules, or in the form of rods, a band or a film.

Examples of co-kneaders that may be used according to the invention are the Buss® MDK 46 co-kneaders and those of the series Buss® MKS or MX, sold by the company Buss AG, which all consist of a threaded shaft bearing wings, arranged in a heated sheath optionally consisting of several parts, the inner wall of which is provided with blending teeth arranged to cooperate with the wings in order to produce shear of the blended material. The shaft is driven in rotation, and given an oscillating motion in the axial direction, by a motor. These co-kneaders may be equipped with a system for manufacturing granules, adapted, for example, onto their outlet orifice, which may consist of an extrusion screw or a pump.

The co-kneaders that may be used according to the invention preferably have a screw ratio L/D ranging from 7 to 22, for example from 10 to 20, whereas co-rotating extruders advantageously have a ratio L/D ranging from 15 to 56, for example from 20 to 50.

The introduction, into the compounding device, of the polymer composition, nanotubes and optional additives may take place in various ways.

Thus, in a first embodiment of the invention, the nanotubes may be introduced into a feed hopper of the compounding device, while the polymer composition is introduced via a separate introduction member. The additives may be introduced into one or other of these feed members.

In a second embodiment of the invention, the polymer composition and the nanotubes may be introduced successively, in any order, into the same feed zone of the mixer. As a variant, they may be introduced simultaneously, into the same feed zone (for example the same hopper), after having been homogenized in a container suitable for forming a premix.

After introduction into the compounding device, the polymer composition and the nanotubes are blended together, with heating, for example at a temperature above the melting point of the polymer composition.

In the second step of the process according to the invention, the particles of core-shell structure described previously are then introduced into the compounding device and the blending is continued. The composition obtained is then extruded and recovered in agglomerated solid form, such as granules, in the third step of the process, in the form of a masterbatch.

It is clearly understood that the process according to the invention may comprise other preliminary or intermediate steps or steps subsequent to those above, provided that they do not harm the dispersion of the nanotubes or the integrity of the polymer composition.

This masterbatch may thus be transported in bags or drums from the production center to the processing center where it may be diluted in a polymer matrix, in accordance with step (d) of the process according to the invention.

This dilution step may be performed using any standard device, in particular by means of internal mixers, or roll mixers or mills (two-roll or three-roll). The amount of masterbatch introduced into the elastomer matrix depends on the nanotube content that it is desired to add to this matrix in order to obtain the desired mechanical and/or electrical and/or thermal properties.

This polymer matrix comprises at least one polymer, which may be identical to or different from that or those used in the manufacture of the masterbatch, and also optionally various additives, such as conductive fillers other than the nanotubes (especially carbon black and/or mineral fillers), lubricants, pigments, stabilizers, fillers or reinforcers, antistatic agents, fungicides, flame retardants, solvents, expansion agents, rheology modifiers, and mixtures thereof.

The composite product obtained after dilution of the masterbatch in the polymer matrix may be formed according to any suitable technique, especially by injection, extrusion, compression or molding, followed by a vulcanization or crosslinking treatment when the polymer matrix comprises an elastomeric or thermosetting resin base. A vulcanizing agent, or a hardener, may have been added to the masterbatch during the compounding step (in the case where its activation temperature is higher than the compounding temperature). However, it is preferable for it to be added to the polymer matrix before or during its forming, so as to have more leeway for adjusting the properties of the final composite product.

As a variant, the dilution of the masterbatch in the polymer matrix may be performed on the dry matter, directly in the tool for forming the composite product, such as an injection device.

In any case, the composite product may especially be used for the manufacture of various products such as cases for electrical or electronic installations, cases for protecting against electromagnetic waves; bodywork or sealing joints, tires; soundproofing plates; static charge dissipaters; internal conductive layers for high-voltage and medium-voltage cables; antivibration systems such as motor vehicle shock absorbers; structural components for bullet-proof vests; fluid transportation or storage devices, such as pipes, reservoirs, offshore pipelines or hoses; or alternatively compact or porous electrodes, especially for supercapacitors or fuel cells.

The invention will be understood more clearly in the light of the nonlimiting and purely illustrative examples that follow.

### EXAMPLES

### Example 1

### Preparation of a Composite Material According to the Invention

The following constituents were introduced into a Clextral BC21 twin-screw extruder:

| | Amount (% by weight) |
|---|---|
| Carbon nanotubes | 15% |
| (Graphistrength ® C100 from | |
| Arkema) | |
| Polycarbonate | 15% |
| (Makrolon ® 2207 from Bayer) | |
| Plasticizing polymer | 40% |
| (CBT ® 100 from Cyclics) | |
| Particles of core-shell | 30% |
| structure (Clearstrength ® | |
| E920 from Arkema) | |

using the following settings:
temperature profile: 70/270/270/270/250/250/250/250/250/250/250/250
Screw speed: 500 revolutions/minute
Flow rate: 7 kg/h.

A masterbatch was obtained, which was diluted in polycarbonate (Makrolon® 2207), under the same blending conditions, except that the flow rate was adjusted to 10 kg/h, to give a composite material containing 2.5% by weight of CNT and 5% by weight of core-shell particles.

### Example 2

### Comparative Test

The composite material of example 1 (hereinbelow, Composite A) was compared with a material (hereinbelow, Composite B) obtained under the same conditions, starting with 15% by weight of carbon nanotubes, 40% by weight of resin CBT® 100 and 45% by weight of polycarbonate. This masterbatch was also diluted in polycarbonate (Makrolon® 2207), under the same blending conditions, except that the flow rate was adjusted to 10 kg/h, to give a composite material containing 2.5% CNT.

Plates of 6×6×0.3 cm, bars and dumbbells were manufactured from Composites A and B, in order to subject them to various electrical and mechanical tests and to compare them with the polycarbonate matrix alone, transformed under the same conditions. The results of these tests are collated in table 1 below.

TABLE 1

| | | | Composite | |
|---|---|---|---|---|
| | | Composite A | B 2.5% | |
| | Standard | 2.5% CNT | CNT | Polycarbonate |
| Surface | ISO 1853 | 5.5 × 10⁷ | 2.8 × 10¹⁰ | 1 × 10¹⁶ |
| resistivity | | | | |
| (ohm/square) | | | | |
| Un-notched | ISO 180 | 147 | 17 | 320 |
| Charpy impact | | | | |
| (kJ/m²) | | | | |
| Notched Charpy | ISO 180 | 19.2 | 4.1 | 8.3 |
| impact (kJ/m²) | | | | |
| Flexural | ISO 178 | 2350 | 2600 | 2300 |
| modulus (MPa) | | | | |
| Ultimate | ISO 527-2 | 50 | 46 | 30 |
| stress (MPa) | 5 mm/min | | | |
| Ultimate | ISO 527-2 | 5.3 | 0.7 | 44 |
| strain (%) | 5 mm/min | | | |

This example demonstrates that the particular morphology of the aggregates formed from the association of the nanotubes with the particles of core-shell structure makes it possible to obtain higher conductivity of the material, while at the same time improving its mechanical properties.

### Example 3

### Preparation of a Composite Material According to the Invention

The constituents below were introduced into a Buss MDK 46 L/D 11 co-kneader:

| | Amount (% by weight) |
|---|---|
| Carbon nanotubes | 20% |
| (Graphistrength ® C100 from | |
| Arkema) | |
| Poly(butylene terephthalate) | 40% |
| (CBT ® 100 from Cyclics) | |
| Particles of core-shell | 40% |
| structure (Clearstrength ® | |
| E920 from Arkema) | |

The CNTs in powder form were introduced into the first zone of the co-kneader (T1=270° C.) with the thermoplastic resin. The primary CNT aggregates were dispersed by means of the restriction ring (diameter: 33.5 cm) separating zones 1 and 2 of the co-kneader. The particles of core-shell structure were introduced into the second zone of the co-kneader in powder form, to form a combination with the CNTs, in the form of aggregates uniformly dispersed in the phase of the thermoplastic resin. The temperature of zone 1 was lowered and maintained at 220° C. A granulation system was provided at the outlet of the uptake extruder.

A masterbatch that is perfectly compatible with a wide range of thermoplastic matrices, having a processing temperature of between 160 and 360° C., was obtained.

### Example 4

### Preparation and Evaluation of the Properties of a Composite Material According to the Invention

Two masterbatches MM1 and MM2 were prepared by introducing the following constituents into a Clextral BC21 twin-screw extruder:

| | |
|---|---|
| MM1 | MM2 |

Amount (weight %)

| | | |
|---|---|---|
| Carbon nanotubes | 10% | 10% |
| (Graphistrength ® C100 from | | |
| Arkema) | | |
| Polycarbonate (Makrolon ® 2207 | 55% | 50% |
| from Bayer) | | |
| Plasticizing polymer (CBT ® 100 | 30% | 20% |
| from Cyclics) | | |
| Particles of core-shell | 5% | 20% |
| structure (Clearstrength ® E920 | | |
| from Arkema) | | |
| Particles/CNT ratio | R1 = 0.5 | R2 = 2 |

The amount of plasticizer was adjusted to obtain composites having the same flow index.

The following settings were used:

Temperature profile: 200/250/250/250/260° C. in the five successive zones of the injection unit
Screw speed: 100 revolutions/minute
Injection speed: 50 and 100 cm³/s
Mold temperature: 80° C.

These two masterbatches MM1 and MM2 were dry-diluted with polycarbonate (Makrolon® 2207), directly in the forming unit by injection of the composite product, to obtain composite materials containing 2.5% by weight of CNT, referred to respectively as Composite 1 and Composite 2, which are in the form of 6×6×0.3 cm plates, bars and dumbbells. These composite products were subjected to various electrical and mechanical tests. The results of these tests are collated in table 2 below.

TABLE 2

| | Standard | Composite 1 | Composite 2 |
|---|---|---|---|
| Surface resistivity on | ISO 1853 | 6 × 10⁶ | 9.3 × 10⁴ |
| Injected squares | | | |
| (Ohm/square) | | | |
| Resistivity per unit | ISO 1853 | 9.1 × 10² | 5.4 × 10² |
| volume on injected bars | | | |
| (Ohm.cm) | | | |
| Un-notched Charpy impact | ISO 180 | 23.2 | 158 |
| (kJ/m²) | | | |
| Notched Charpy impact | ISO 180 | 3.59 | 9 |
| (kJ/m²) | | | |
| Notched IZOD impact | ISO 180 | 3.6 | 7.5 |
| (kJ/m²) | | | |
| Flexural modulus (MPa) | ISO 178 | 2768 | 2407 |
| Ultimate stress (MPa) | ISO 527-2, | 57 | 57.2 |
| | 5 mm/min | | |
| Ultimate strain (%) | ISO 527-2, | 1.6 | 4.8 |
| | 5 mm/min | | |

This example demonstrates that Composite 2 according to the invention, which has a weight ratio R2 of the core-shell particles to the CNT of 2, offers better electrical and mechanical properties than Composite 1 which has a ratio R1 of 0.5.

1. A composite material comprising, in a polymer composition, carbon nanotubes associated, so as to form aggregations of less than 30 μm, with particles having a core made of totally or partially crosslinked elastomer and at least one thermoplastic shell, in a weight ratio of the particles of core-shell structure to the nanotubes of between 0.5:1 and 2.5:1.

2. The material as claimed in claim 1, wherein it contains from 0.1% to 40% by weight of carbon nanotubes.

3. The material as claimed in claim 1, wherein the weight ratio of the particles of core-shell structure to the nanotubes is between 1.5:1 and 2.5:1.

4. The material as claimed in claim 1, wherein it contains from 0.1% to 80% by weight of particles of core-shell structure.

5. The material as claimed in claim 1, wherein the particles of core-shell structure have a size of between 50 and 1000 nm.

6. The material as claimed in claim 1, wherein said particles of core-shell structure also contain a rigid nucleus.

7. The material as claimed in claim 1, wherein the core is chosen from the group consisting of:
isoprene homopolymers, butadiene homopolymers or homopolymers of an alkyl(meth)acrylate, and
copolymers of isoprene with not more than 30 mol % of a vinyl monomer, copolymers of butadiene with not more than 30 mol % of a vinyl monomer and copolymers of an alkyl(meth)acrylate with not more than 30 mol % of a vinyl monomer.

8. The material as claimed in claim 7, wherein the vinyl monomer is chosen from the group consisting of styrene, an alkylstyrene, acrylonitrile, butadiene, isoprene and an alkyl(meth)acrylate, wherein said vinyl monomer is different from the monomer with which the vinyl monomer is copolymerized.

9. The material as claimed in claim 1, wherein the shell consists of:
a styrene homopolymer, an alkylstyrene homopolymer or a methyl methacrylate homopolymer; or
a copolymer comprising at least 70 mol % of a major monomer chosen from styrene, an alkylstyrene or methyl methacrylate and at least one comonomer chosen from:
a C₁-C₂₀ alkyl(meth)acrylate,
vinyl acetate,
unsaturated nitriles,
acrylamides,
a vinylaromatic compound, which are optionally halogenated and/or alkylated,
vinyl monomers containing a glycidyl group, and
mixtures thereof,
wherein the major monomer and the comonomer are different.

10. The material as claimed in claim 1, wherein said polymer composition comprises at least one polymer chosen from: a thermoplastic polymer, an elastomer resin base and a thermosetting resin base.

11. The material as claimed in claim 1, wherein the material also comprises at least one other filler chosen from: carbon black, graphene-based fillers, fullerenes, graphite and carbon nanofibers.

12. The material as claimed in claim 1, wherein the material consists of the mixture of nanotubes, particles of core-shell structure, the polymer composition and optionally at least one non-polymeric additive, and in that the polymer composition contains at least 90% by weight of one or more polymers.

13. The material as claimed in claim 1, wherein the carbon nanotubes and the core-shell particles form aggregations in which the median diameter (D50), observed by optical microscopy, is less than 30 μm.

14. A process for preparing a composite material as claimed in claim 1, which is in the form of a masterbatch or of a composite product, said process comprising the successive steps of:
(a) introducing, and then blending, in a compounding device, the carbon nanotubes, the polymer composition and optional additives, to obtain a homogeneous mixture,
(b) adding the particles of core-shell structure to said mixture in said device and continuing the blending,
(c) extruding and recovering, in agglomerated solid form such as granules, the composition derived from step (b), to obtain a masterbatch,
(d) optionally, diluting said masterbatch in a polymer matrix containing at least one polymer chosen from: an elastomer resin base, a thermosetting resin base and a thermoplastic polymer, to obtain a composite product.

15. A method of improving the electrical, thermal and/or mechanical properties of a polymer matrix, the method comprising adding a composite material as claimed in claim 1, as a masterbatch to the polymer matrix.
